(19) United States
(12) Patent Application Publication
(10) Pub. No.: US 2022/0196545 A1
(43) Pub. Date: Jun. 23, 2022

(54) MOISTURE SENSING DEVICE

(71) Applicant: Panasonic Intellectual Property Management Co., Ltd., Osaka (JP)

(72) Inventors: Kosuke IMAWAKA, Kyoto (JP); Hiroyuki FURUYA, Osaka (JP); Akira KUROZUKA, Osaka (JP)

(21) Appl. No.: 17/690,836

(22) Filed: Mar. 9, 2022

Related U.S. Application Data
(63) Continuation of application No. PCT/JP2020/022418, filed on Jun. 5, 2020.

(30) Foreign Application Priority Data
Sep. 11, 2019 (JP) 2019-165472

(51) Int. Cl. G01N 21/31; G02B 27/14; G02B 27/28

(52) U.S. Cl. CPC G01N 21/31; G01N 2201/0636; G02B 27/283; G02B 27/141

(57) ABSTRACT

A moisture sensing device includes: a light source part; a projection optical system configured to project illumination light emitted from the light source part, onto a road surface; a photodetector configured to receive reflected light of the illumination light reflected by the road surface; a light-receiving optical system configured to condense the reflected light onto the photodetector; and an optical element configured to align the optical axis of the projection optical system and the optical axis of the light-receiving optical system with each other in a range on the road surface side.

### CROSS REFERENCE TO RELATED APPLICATION

This application is a continuation of International Application No. PCT/JP2020/022418 filed on Jun. 5, 2020, entitled “MOISTURE SENSING DEVICE”, which claims priority under 35 U.S.C. Section 119 of Japanese Patent Application No. 2019-165472 filed on Sep. 11, 2019, entitled “MOISTURE SENSING DEVICE”. The disclosures of the above applications are incorporated herein by reference.

### BACKGROUND OF THE INVENTION

### 1. Field of the Invention

The present invention relates to a moisture sensing device that senses the state of moisture at a target object, and that is suitably used when sensing the state of water, ice, snow, and the like deposited on a road surface, for example.

### 2. Disclosure of Related Art

To date, a road surface sensing device that senses the state of a road surface has been known. For example, Japanese Laid-Open Patent Publication No. 2001-216592 describes a road surface state sensing device that applies illumination light to a sensing target region of a road surface and that determines, on the basis of reflected light thereof, whether or not a sensing target object such as ice or water is present in the sensing target region. In this device, as the illumination light, detection light and reference light having wavelengths different from each other are sequentially switched and applied to the sensing target region. In addition, in synchronization with the switching of the lights, reflected light of each light is received and an electric signal is generated. These electric signals are subjected to comparison operation, and whether or not a sensing target object such as water or ice is present in the sensing target region is determined on the basis of the operation result.

In the configuration according to the above Japanese Laid-Open Patent Publication. No. 2001-216592, illumination light and reflected light are individually applied and received by separate optical systems, respectively, in directions different from each other. Therefore, the application angle of illumination light and the reception angle of reflected light need to be adjusted in accordance with the distance between the road surface state sensing device and the sensing region. Such adjusting work is very complicated.

### SUMMARY OF THE INVENTION

A moisture sensing device of a main mode of the present invention includes: a light source part; a projection optical system configured to project illumination light emitted from the light source part, onto a target object; a photodetector configured to receive reflected light of the illumination light reflected by the target object; a light-receiving optical system configured to condense the reflected light onto the photodetector; and an optical element configured to align an optical axis of the projection optical system and an optical axis of the light-receiving optical system with each other in a range on a side of the target object.

In the moisture sensing device according to the present mode, the optical axis of the projection optical system and the optical axis of the light-receiving optical system are aligned with each other in a range on the target object side. Therefore, out of the reflected lights reflected by the target object, reflected light that travels backward along the aligned optical axis can be condensed on the photodetector by the light-receiving optical system. Therefore, the angles of illumination light and reflected light with respect to the target object need not be adjusted in accordance with the distance between the device and the target object. Without such adjustment, the reflected light from the target object can be appropriately received by the photodetector.

### BRIEF DESCRIPTION OF THE DRAWINGS

FIG. 1 shows a configuration of an optical system of a moisture sensing device according to an embodiment;

FIG. 2A and FIG. 2B are a perspective view and a side view, respectively, each showing a configuration of an optical element according to the embodiment;

FIG. 3 is a block diagram showing a configuration of a circuit part of the moisture sensing device according to the embodiment;

FIG. 4 is a graph showing absorption coefficient of light at water and ice, according to the embodiment;

FIG. 5 is a flow chart showing a determination process performed by the moisture sensing device according to the embodiment;

FIG. 6A schematically shows an example of an installation state of the moisture sensing device according to the embodiment;

FIG. 6B is a graph showing a relationship between incidence angle and reflectance of light with respect to a water surface, according to the embodiment;

FIG. 7 is a graph showing a relationship between pulse width and peak power that satisfy a condition for realizing class 1 of a laser safety standard, according to the embodiment;

FIG. 8 schematically shows a configuration of a road surface information delivery system, according to the embodiment;

FIG. 9 shows a configuration of an optical system of the moisture sensing device according to Modification 1;

FIG. 10A shows a simulation result obtained through simulation of a condensed state of reflected lights when the reflected lights have been condensed on a photodetector by a condenser lens, according to Modification 1;

FIG. 10B shows a simulation result obtained through simulation of a condensed state of reflected lights when the reflected lights have been condensed on the photodetector by a reflection surface having a paraboloid shape, according to the embodiment;

FIG. 11 shows a configuration of an optical system of the moisture sensing device according to Modification 2;

FIG. 12 shows another configuration of an optical system of the moisture sensing device according to Modification 2; and

FIG. 13 shows a configuration of an optical system of the moisture sensing device according to Modification 3.

It should be noted that the drawings are solely for description and do not limit the scope of the present invention by any degree.

### DESCRIPTION OF PREFERRED EMBODIMENTS

Hereinafter, an embodiment of the present invention will be described with reference to the drawings. In the present embodiment, the present invention is applied to a moisture sensing device that senses moisture (water, snow, ice, or the like) deposited on a road surface serving as a target object.

<Configuration of Optical System>

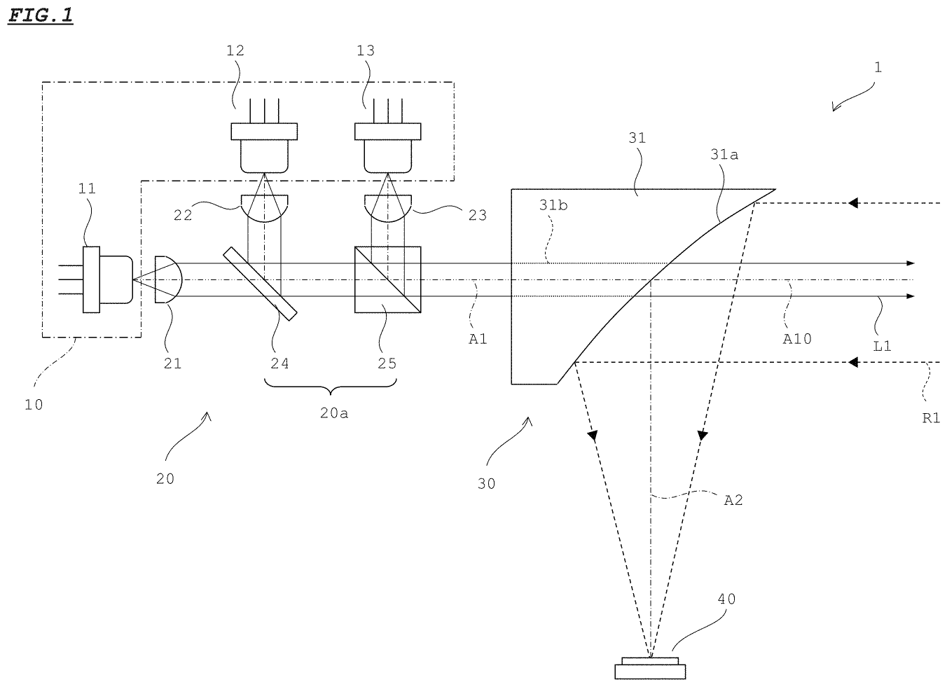

FIG. 1 shows a configuration of an optical system of a moisture sensing device 1.

The moisture sensing device 1 includes a light source part 10, a projection optical system 20, a light-receiving optical system 30, and a photodetector 40. The light source part 10 emits a plurality of illumination lights L1 having wavelengths different from each other. The projection optical system 20 projects each illumination light L1 emitted from the light source part 10, onto a road surface. The photodetector 40 receives reflected light R1 of the illumination light L1 reflected by the road surface.

The light source part 10 includes three light sources 11, 12, 13 having wavelengths different from each other. The light sources 11, 12, 13 are each a laser light source such as a semiconductor laser, for example. The light sources 11, 12, 13 may each be implemented as an LED, or a white light source provided with a filter that allows a specific wavelength to pass therethrough. The light source 11 emits near infrared light having a wavelength of 980 nm (hereinafter, referred to as a “reference wavelength”). The light source 12 emits near infrared light having a wavelength of 1450 nm (hereinafter, referred to as an “absorption wavelength 1”). The light source 13 emits near infrared light having a wavelength of 1550 nm (hereinafter, referred to as an “absorption wavelength 2”).

The light sources 12, 13 each emit illumination light L1 in the same direction, and the light source 11 applies illumination light L1 in a direction orthogonal to the emission direction of the light sources 12, 13. The emission optical axes of the light sources 11, 12, 13 are included in the same plane. That is, the emission optical axis of the light source 11 and the emission optical axes of the light sources 12, 13 are orthogonal to each other.

The projection optical system 20 includes collimator lenses 21, 22, 23, a dichroic mirror 24, and a polarization beam splitter (hereinafter, referred to as “PBS”) 25. The collimator lenses 21, 22, 23 convert illumination lights L1 emitted from the light sources 11, 12, 13, into collimated lights, respectively. The dichroic mirror 24 allows the illumination light L1 emitted from the light source 11, to transmit therethrough, and reflects the illumination light L1 emitted from the light source 12. Accordingly, the emission optical axis of the light source 11 and the emission optical axis of the light source 12 are aligned with each other.

The PBS 25 allows the two illumination lights L1 incident thereon from the dichroic mirror 24 side, to transmit through the PBS 25, and reflects the illumination light L1 emitted from the light source 13. That is, the light sources 11, 12 are disposed such that the polarization direction is p-polarized with respect to the PBS 25, and the light source 13 is disposed such that the polarization direction is s-polarized with respect to the PBS 25. Accordingly, the emission optical axes of the light sources 11, 12, 13 are aligned with an optical axis A1 of the projection optical system 20. The dichroic mirror 24 and the PBS 25 form an alignment optical system 20a which aligns the emission optical axes of the light sources 11, 12, 13 with each other.

The light-receiving optical system 30 includes an optical element 31. The optical element 31 aligns the optical axis A1 of the projection optical system 20 and an optical axis A2 of the light-receiving optical system 30 with each other, in a range on the road surface side (a range in the projection direction of illumination light L1 from the optical element 31). That is, these two optical axes A1, A2 are integrated into a common optical axis A10 by the optical element 31.

The optical element 31 has a reflection surface 31a at a face on the side opposite to the projection optical system 20. The reflection surface 31a is a paraboloid that is concave inward of the optical element 31. The reflection surface 31a condenses reflected light R1 incident thereon along the optical axis A10, onto the light-receiving surface of the photodetector 40. The optical axis of the reflection surface 31a serves as the optical axis A2 of the light-receiving optical system 30.

The optical axis A2 is perpendicular to the optical axis A1 of the projection optical system 20. The optical axis A1 and the optical axis A2 may not necessarily be perpendicular to each other, and may have a different angle therebetween. In this case, in accordance with the angle between the optical axis A1 and the optical axis A2, the shape of the reflection surface 31a is changed, and the disposition of the photodetector 40 is adjusted such that the light-receiving surface thereof becomes perpendicular to the optical axis A2.

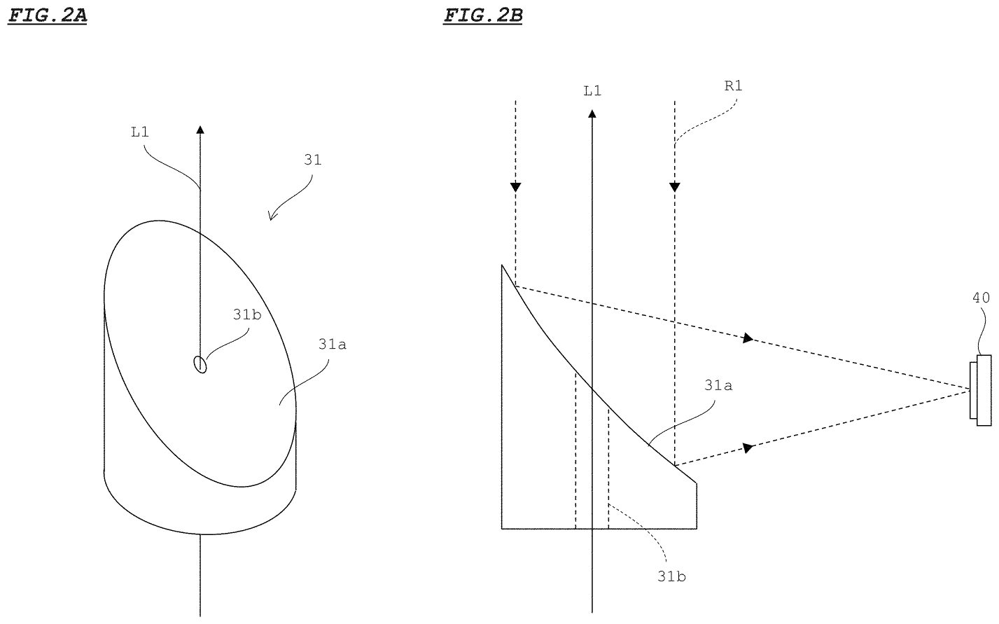

FIG. 2A and FIG. 2B are a perspective view and a side view, respectively, each showing a configuration of the optical element 31.

The optical element 31 has a shape obtained by obliquely cutting off the upper face of a columnar member. In addition to the reflection surface 31a, the optical element 31 has formed therein an opening 31b for allowing illumination light L1 projected from the projection optical system 20, to pass therethrough. Here, the opening 31b is formed as a through-hole that penetrates the optical element 31 along the central axis of the optical element 31. Instead of the through-hole, a slit-like cutout extending from the outer side face of the optical element 31 to the central axis thereof may be formed, to provide the opening 31b. As shown in FIG. 2B, the illumination light L1 passes through the opening 31b, to be projected onto the road surface. The reflected light R1 from the road surface is condensed by the reflection surface 31a onto the photodetector 40.

With reference back to FIG. 1, the photodetector 40 is implemented by a photodiode, for example. As the photodetector 40, a photodiode that has a detection sensitivity in an infrared waveband (e.g., 900 to 1800 nm) can be used. When the photodetector 40 has a detection sensitivity also in a visible light waveband, a filter that allows transmission therethrough of the reference wavelength, the absorption wavelength 1, and the absorption wavelength 2 being emission wavelengths of the light sources 11, 12, 13, and that blocks the visible light waveband, may be disposed before the photodetector 40. The photodetector 40 may be implemented by an avalanche photodiode.

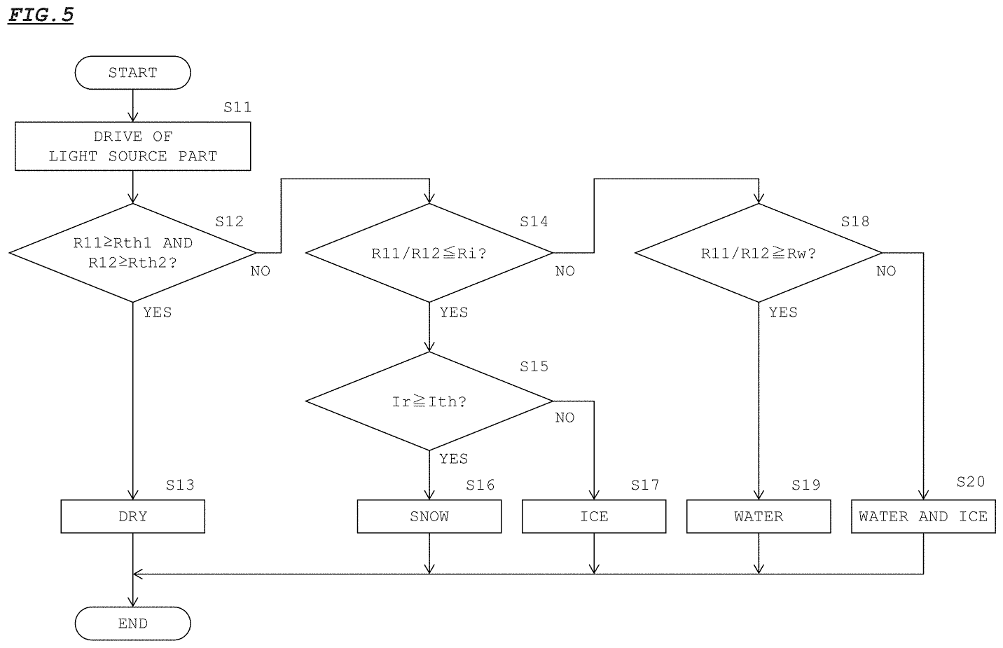

The photodetector 40 receives the reflected lights R1, which are the illumination lights L1 having been emitted from the light sources 11, 12, 13 and reflected by the road surface, and outputs electric signals based on the amounts of the received lights. In the present embodiment, the light sources 11, 12, 13 are driven so as to emit light in a pulsed manner in a time-division manner. Therefore, the photodetector 40 receives, in a time-division manner, the reflected lights R1 based on the illumination lights L1 from the light sources 11, 12, 13, and outputs electric signals according to the amounts of the respective received reflected lights R1. On the basis of the electric signal according to each reflected light R1 and outputted from the photodetector 40, the type (the state of moisture) of a deposit on the road surface is determined. The deposit determination process will be described later with reference to FIG. 5.

<Configuration of Circuit Part>

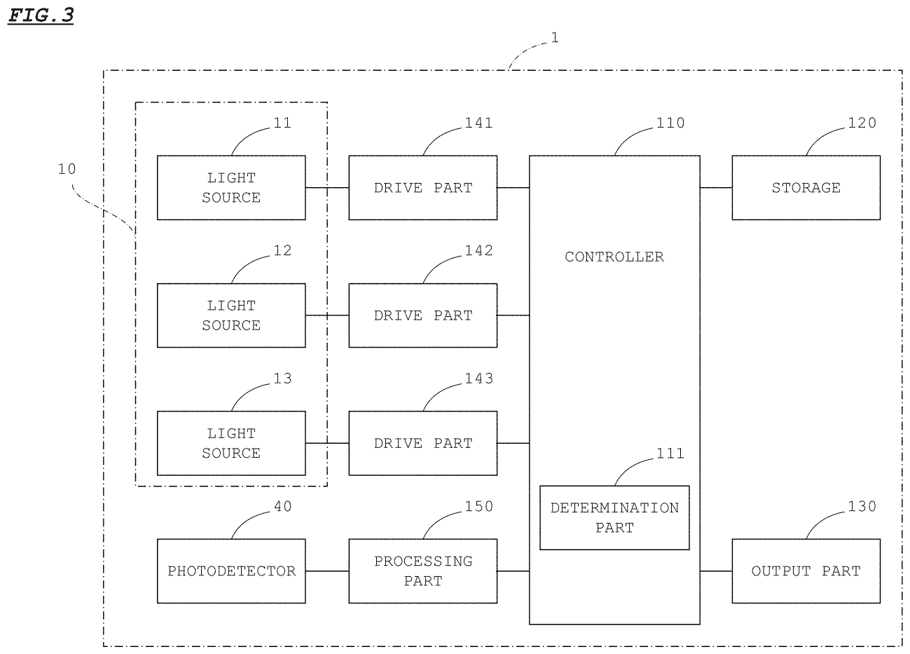

FIG. 3 is a block diagram showing a configuration of a circuit part of the moisture sensing device 1.

The moisture sensing device 1 includes: a controller 110; a storage 120; an output part 130; three drive parts 141, 142, 143; and a processing part 150, in addition to the light sources 11, 12, 13 and the photodetector 40 shown in FIG. 1.

The controller 110 is implemented by a CPU or a microcomputer, for example. The controller 110 performs control of components in the moisture sensing device 1, in accordance with a control program stored in the storage 120. As a function realized by the control program, a determination part 111 is provided in the controller 110. The determination part 111 determines the type (water, snow, ice) of the deposit on the road surface on the basis of a detection signal from the photodetector 40. The determination part 111 may be implemented as hardware, not as a function realized by the control program.

The storage 120 includes a memory, stores the control program, and is used as a work region during control processing. The output part 130 outputs a determination result of the determination part 111. The output part 130 may be a display part such as a monitor provided to the moisture sensing device 1, or may be a communication module for transmitting a determination result of the determination part 111 to an external processing device such as a server.

The drive parts 141, 142, 143 drive the light sources 11, 12, 13, respectively, in accordance with control from the controller 110. The processing part 150 converts an electric signal inputted from the photodetector 40 into a digital signal and takes a logarithm thereof, and outputs the logarithm to the controller 110. The controller 110 determines the type (the state of moisture) of the deposit on the road surface on the basis of a detection signal inputted from the processing part 150. This determination is performed by the determination part 111 as described above.

<Determination Method>

Next, a determination method for the type of a deposit is described.

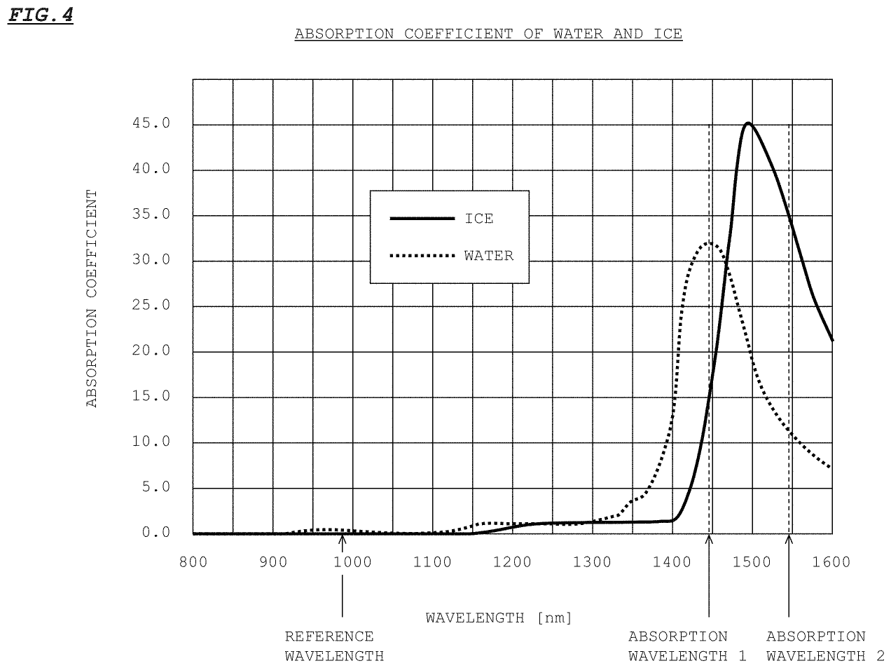

FIG. 4 is a graph showing absorption coefficient of light at water and ice.

In FIG. 4, the reference wavelength, the absorption wavelength 1, and the absorption wavelength 2 set as the emission wavelengths of the light sources 11, 12, 13 are indicated by arrows, respectively.

As shown in FIG. 4, the absorption coefficients of the reference wavelength with respect to water and ice are smaller than the absorption coefficients of the absorption wavelength 1 and the absorption wavelength 2. That is, illumination light L1 having the reference wavelength is less absorbed by water and ice than illumination lights L1 having the absorption wavelength 1 and the absorption wavelength 2. Therefore, illumination light L1 (the reference wavelength) emitted from the light source 11 is easily reflected by a road surface even when moisture (water, ice, snow) is present in an irradiation region on the road surface, and the amount of the reflected light R1 of the illumination light L1 (the reference wavelength) received by the photodetector 40 is large. On the other hand, as for the absorption wavelengths 1, 2 of lights emitted from the light sources 12, 13, absorption coefficients by water and ice are large. Therefore, when there is moisture in the irradiation region, illumination lights L1 having the absorption wavelengths 1, 2 are absorbed by the moisture, and the amount of reflected lights R1 having the absorption wavelengths 1, 2 and received by the photodetector 40 are small.

Thus, when detection signals with respect to the illumination lights L1 having the absorption wavelengths 1, 2 are normalized by a detection signal with respect to the illumination light L1 having the reference wavelength which is less likely to be influenced by moisture, noise components such as scattering due to the shape of the road surface can be suppressed.

In the present embodiment, using the difference in absorption coefficient between the absorption wavelength 1 and the absorption wavelength 2, discernment between water and ice is performed. That is, as for the absorption wavelength 1 (1450 nm), the absorption coefficient by water is large relative to the absorption coefficient by ice, and as for the absorption wavelength 2 (1550 nm), the absorption coefficient by ice is large relative to the absorption coefficient by water. Therefore, by taking the ratio of detection signals corresponding to the absorption wavelength 1 and the absorption wavelength 2, it is possible to discern whether the moisture is water or ice, when there is moisture is present at an irradiation position.

FIG. 5 is a flow chart showing a determination process of the type of a deposit performed by the controller 110 (the determination part 111).

First, the controller 110 drives the light source part (S11). Specifically, via the drive parts 141, 142, 143, the controller 110 causes the light sources 11, 12, 13 to emit illumination lights L1 in a time-division manner. Then, the controller 110 obtains, via the processing part 150, a detection signal outputted from the photodetector 40 in accordance with the drive of the light source 11, a detection signal outputted from the photodetector 40 in accordance with the drive of the light source 12, and a detection signal outputted from the photodetector 40 in accordance with the drive of the light source 13.

Next, the determination part 111 of the controller 110 determines the state of the irradiation position on the basis of the intensity of the detection signal corresponding to the reference wavelength, the intensity of the detection signal corresponding to the absorption wavelength 1, and the intensity of the detection signal corresponding to the absorption wavelength 2.

Specifically, when a value R11 obtained through logarithmic conversion of the ratio of the intensity of the detection signal corresponding to the absorption wavelength 1 relative to the intensity of the detection signal corresponding to the reference wavelength is not less than a threshold Rth1, and a value R12 obtained through logarithmic conversion of the ratio of the intensity of the detection signal corresponding to the absorption wavelength 2 relative to the intensity of the detection signal corresponding to the reference wavelength is not less than a threshold Rth2 (S12: YES), the determination part 111 determines that moisture is not present at the irradiation position (the irradiation position is dry).

Here, the threshold Rth1 is a value obtained by subtracting the value of the absorption coefficient at the absorption wavelength 1 (1450 nm) with respect to water from the value of the absorption coefficient at the reference wavelength (980 nm) with respect to water, and multiplying the resultant value by a doubled value of a thickness at which water is determined to be present. For example, when water having a thickness of not less than 10 μm is sensed, the value of Rth1 is −0.062. The threshold Rth2 is a value obtained by subtracting the value of the absorption coefficient at the absorption wavelength 2 (1550 nm) with respect to ice from the value of the absorption coefficient at the reference wavelength (980 nm) with respect to ice, and multiplying the resultant value by a doubled value of a thickness at which ice is determined to be present. For example, when ice having a thickness of not less than 10 μm is sensed, the value of Rth2 is −0.069.

When the determination in step S12 is NO, the determination part 111 determines that moisture is present at the irradiation position, and advances the process to step S14.

In step S14, the determination part 111 calculates the ratio of the value R11 to the value R12, and determines whether or not the obtained value is not greater than a threshold Ri. Here, the value of the threshold Ri is the ratio of a value obtained by subtracting the absorption coefficient at the reference wavelength (980 nm) from the absorption coefficient at the absorption wavelength 1 (1450 nm) at ice, and a value obtained by subtracting the absorption coefficient at the reference wavelength (980 nm) from the absorption coefficient at the absorption wavelength 2 (1550 nm) at ice.

When the ratio of the value R11 to the value R12 is not greater than the threshold Ri (S14: YES), the determination part 111 determines that only ice or snow is present at the irradiation position, and advances the process to step S15. When the ratio of the value R11 to the value R12 exceeds the threshold Ri (S14: NO), the determination part 111 determines that water, or water and ice is present at the irradiation position, and advances the process to step 18.

In step S15, the determination part 111 determines whether or not a received-light intensity Ir at the reference wavelength is not less than a threshold Ith. Here, when the received-light intensity Ir is not less than the threshold Ith (S15: YES), the determination part 111 determines that snow is present at the irradiation position (S16). Meanwhile, when the received-light intensity Ir is less than the threshold Ith (S15: NO), the determination part 111 determines that ice is present at the irradiation position (S17). Here, after the determination part 111 has determined that snow or ice is present, the controller 110 may measure the thickness thereof from the values of the detection signals corresponding to the reference wavelength and the absorption wavelength 1.

In step S18, the determination part 111 calculates the ratio of the value R11 to the value R12, and determines whether or not the obtained value is not less than a threshold Rw. When the ratio of the value R11 to the value R12 is not less than the threshold Rw (S18: YES), the determination part 111 determines that water is present at the irradiation position (S19). Here, after the determination part 111 has determined that water is present at the irradiation position, the controller 110 may further measure the thickness of the water from the values of the detection signals corresponding to the reference wavelength and the absorption wavelength 2.

Meanwhile, when the ratio of the value R11 to the value R12 is less than the threshold Rw (S18: NO), i.e., when Ri≤R11/R12<Rw is satisfied, the determination part 111 determines that a mixture of water and ice is present at the irradiation position (S20). Here, the controller 110 may compare the value of (R11/R12-Ri) and the value of (Rw-R11/R12) with each other to calculate the proportion of water and ice present at the irradiation position, thereby measuring the thickness of the layer of the mixture of water and ice from the proportion and the values of the detection signals corresponding to the reference wavelength, the absorption wavelength 1, and the absorption wavelength 2.

<Light Source Arrangement Method>

Next, a relationship between the detection sensitivity of the photodetector 40 with respect to the reference wavelength and the absorption wavelengths 1, 2, and the arrangement method for the light sources 11, 12, 13, is described.

For example, when the detection sensitivity of the photodetector 40 with respect to the reference wavelength, out of the reference wavelength and the absorption wavelengths 1, 2, is lowest, and the detection sensitivity of the photodetector 40 with respect to the absorption wavelength 2 is highest, it is preferable that an amount as large as possible of the reflected light R1 of the illumination light L1 having the reference wavelength is received by the photodetector 40. Here, the reflectance of illumination light L1 with respect to the road surface varies in accordance with the polarization direction of the illumination light L1 with respect to the road surface.

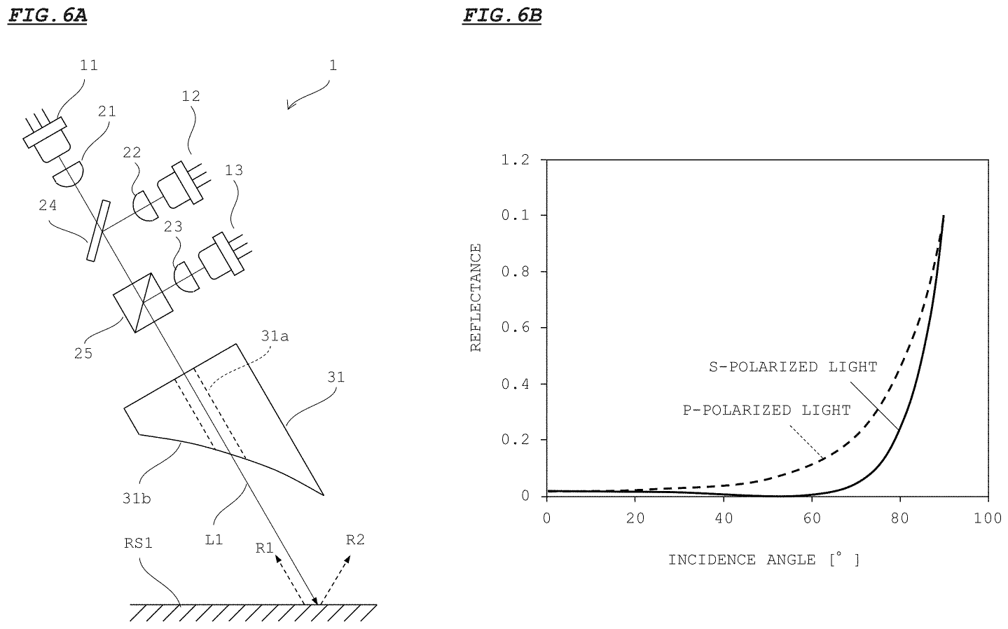

FIG. 6A schematically shows an example of an installation state of the moisture sensing device 1. FIG. 6B is a graph showing a relationship between incidence angle and reflectance of light with respect to a water surface. For convenience, the photodetector 40 is not shown in FIG. 6A.

In the case of FIG. 6A, the moisture sensing device 1 is installed such that the illumination light L1 is incident on the road surface in an oblique direction with respect to the road surface. For example, when the moisture sensing device 1 is installed to a pole or the like on a lateral side of a road, the moisture sensing device 1 is installed in a state of being tilted with respect to a road surface RS1, as shown in FIG. 6A. In this case, the illumination light L1 is mirror-reflected by the road surface RS1 or a deposit thereon. Reflected light R2 that has been mirror-reflected is not incident on the reflection surface 31a of the optical element 31, and thus, this reflected light R2 is not received by the photodetector 40. In this case, reflected light R1 reflected by the road surface RS1 in a backward direction of the optical path of the illumination light L1 is incident on the reflection surface 31a of the optical element 31, to be condensed by the photodetector 40.

Here, when the illumination light L1 is incident from an oblique direction with respect to the road surface RS1 as shown in FIG. 6A, the reflectance differs in accordance with the polarization direction of light with respect to the road surface RS1. In this case, the greater the reflectance is, the greater the amount of loss of light due to mirror-reflection is. Therefore, the amount of reflected light R1 received by the photodetector 40 decreases. For example, when water is present at the road surface RS1, the reflectance of s-polarized light is greater than the reflectance of p-polarized light at substantially all of the incidence angles, as shown in FIG. 6B. Therefore, when the illumination light L1 is incident in an s-polarized manner, the light reception efficiency relative to the emission power is more impaired.

Therefore, as described above, when the detection sensitivity of the photodetector 40 with respect to the reference wavelength, out of the reference wavelength and the absorption wavelengths 1, 2, is lowest, arrangement of the light sources 11, 12, 13 is preferably set such that the illumination light L1 having the reference wavelength is incident on the road surface RS1 in a p-polarized manner. Specifically, in the configuration shown in FIG. 6A, the light source 11, which emits illumination light L1 having a reference wavelength at which the detection sensitivity is lowest, is disposed such that the illumination light L1 is p-polarized with respect to the road surface RS1. Accordingly, decrease in the light reception efficiency at the photodetector 40 of the reflected light R1 having the reference wavelength can be suppressed.

It is also preferable that illumination light L1 having the absorption wavelength 1 at which the detection sensitivity at the photodetector 40 is second lowest is incident on the road surface RS1 so as to be p-polarized with respect to the road surface RS1. In the configuration shown in FIG. 6A, the light source 12, which emits illumination light L1 having the absorption wavelength 1, may be disposed such that the illumination light L1 is p-polarized with respect to the road surface RS1. Accordingly, decrease in the light reception efficiency at the photodetector 40 of the reflected light R1 having the absorption wavelength 1 can be suppressed.

When the light sources 11, 12 are disposed in this manner, the polarization directions of the illumination lights L1 respectively emitted from these light sources 11, 12 match each other. Therefore, these illumination lights L1 can be caused to be incident on the PBS 25 so as to be p-polarized with respect to the PBS 25. This allows the illumination lights L1 respectively emitted from these light source 11, 12 to transmit through the PBS 25.

In this configuration, illumination light L1 having the absorption wavelength 2 and emitted from the light source 13 is incident on the road surface RS1 so as to be s-polarized with respect to the road surface RS1. Thus, the light reception efficiency at the photodetector 40 of the reflected light R1 of this illumination light L1 decreases when compared with those of the other two illumination lights L1. However, the detection sensitivity at the absorption wavelength 2 of the photodetector 40 is higher than those at the reference wavelength and the absorption wavelength 1 as described above. Therefore, even when the light reception efficiency of the illumination light L1 having the absorption wavelength 2 and emitted from the light source 13 decreases, the magnitude of the detection signal based on the reflected light R1 having the absorption wavelength 2 does not become extremely small.

Therefore, by adjusting the arrangement of the light sources 11, 12, 13 as described above, it is possible to prevent the magnitude of the detection signal of the reflected light R1 having any of the reference wavelength and the absorption wavelengths 1, 2 from becoming extremely small. Therefore, the determination of the type of a deposit shown in FIG. 5 and the determination of the thickness of the deposit can be accurately performed.

It should be noted that FIG. 6A shows the arrangement positions of the light sources 11, 12, 13 when the detection sensitivity of the photodetector 40 with respect to the reference wavelength, out of the reference wavelength and the absorption wavelengths 1, 2, is lowest and the detection sensitivity of the photodetector 40 with respect to the absorption wavelength 2 is highest. However, when the detection sensitivity of the photodetector 40 with respect to each wavelength is different from that of this configuration, the arrangement of the light sources 11, 12, 13 may be adjusted such that: illumination light L1 having a wavelength at which the detection sensitivity is lowest and illumination light L1 having a wavelength at which the detection sensitivity is second lowest are p-polarized with respect to the road surface RS1; and illumination light L1 having the other wavelength is s-polarized with respect to the road surface RS1. Alternatively, it is sufficient that at least illumination light L1 having a wavelength at which the detection sensitivity of the photodetector 40 is lowest is set to be p-polarized with respect to the road surface RS1, and which of illumination lights L1 having the remaining two wavelengths is set to be p-polarized with respect to the road surface RS1 may be determined as desired.

When there is a difference in transmission efficiency and reflection efficiency of light with respect to the dichroic mirror 24, arrangement of two light sources that each cause illumination light L1 to be incident on the dichroic mirror 24 may be adjusted on the basis of the difference. For example, when the transmission efficiency is higher than the reflection efficiency, i.e., when loss of light due to transmission is less than loss of light due to reflection, the light sources 11, 12 are preferably disposed such that: illumination light L1 (emission light of the light source 11) having the reference wavelength at which the detection sensitivity at the photodetector 40 is lowest transmits through the dichroic mirror 24; and illumination light L1 (emission light of the light source 12) having the absorption wavelength 1 is reflected by the dichroic mirror 24, as shown in FIG. 6A. Accordingly, decrease in the received amount of the reflected light R1 having the reference wavelength can be prevented. Therefore, the magnitude of the detection signal of the reflected light R1 having the reference wavelength at which the detection sensitivity is lowest can be prevented from becoming extremely small.

<Emission Power Setting Method>

Next, a setting method for emission powers of the light sources 11, 12, 13 is described.

When the light sources 11, 12, 13 are laser light sources, emission powers of the light sources 11, 12, 13 need to satisfy a laser light safety standard.

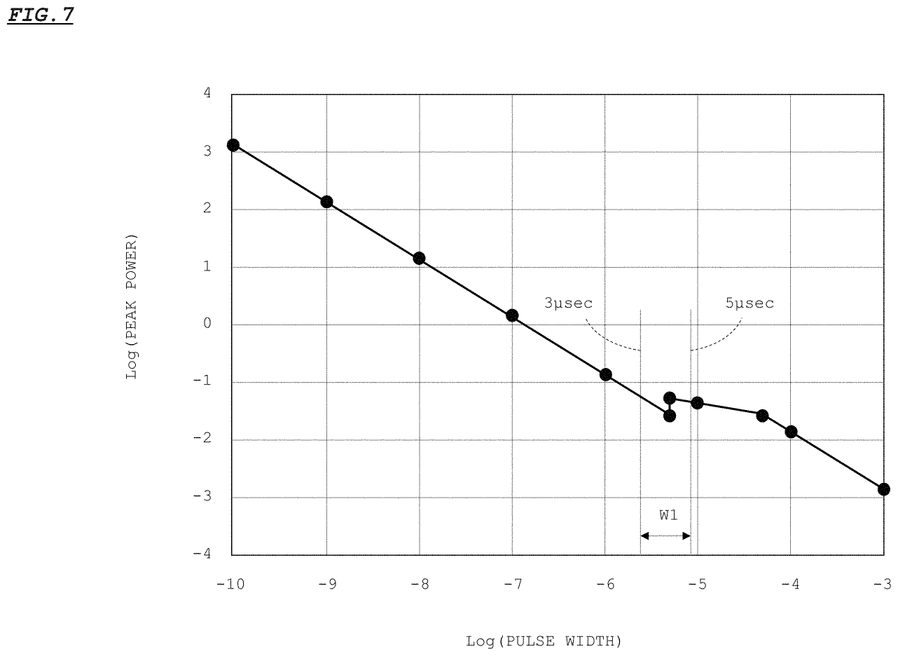

FIG. 7 is a graph showing a relationship between pulse width and peak power that satisfy a condition for realizing class 1 of the laser safety standard when the wavelength is 980 nm, the repetition frequency is 1 kHz, and the visual angle is 1.5 mrad.

The pulse width of illumination light L1 emitted from each of the light sources 11, 12, 13 of the moisture sensing device 1 is restricted by the response frequency of the photodetector 40. For example, with reference to the graph in FIG. 7, when illumination light L1 (the reference wavelength: 980 nm) having a pulse width of not less than 3 μsec is used, a peak power that is allowed, in a region W1 where the pulse width is not less than 2.6 μsec and less than 5 μsec, is less than the peak power when the pulse width is 5 psec.

Meanwhile, Japanese Industrial Standards (JIS C68002_002) indicates that a peak power allowed at a certain pulse width is also allowed at a pulse width smaller than that. In accordance with this, for example, when a peak power that is allowed at a pulse width of 5 μsec is used at a pulse width of 3 μsec, energy consumption can be reduced when compared with a case where the pulse width is set to 5 μsec. Similarly, in the region W1 where the pulse width is not less than 2.6 μsec and less than 5 μsec, when a peak power that is allowed at a pulse width of 5 μsec is used, energy consumption can be reduced when compared with a case where the pulse width is set to 5 μsec.

In the case of the illumination light L1 having the reference wavelength (980 nm), when the peak power allowed at a pulse width of 5 μsec is used in a region where the pulse width is smaller than 5 μsec, the frequency band in which a power larger than the peak power allowed at the actual pulse width can be used is about 60 Hz to 14 kHz.

In the cases of the illumination light having the absorption wavelength 1 (1450 nm) and the illumination light having the absorption wavelength 2 (1550 nm), the region where a larger power can be used by using the peak power allowed at a pulse width larger than the actual pulse width is not present in a range where the pulse width is 10\hat{ }(−3) μsec to 10\hat{ }(−10) μsec.

### System Configuration Example

Next, a system configuration example using the moisture sensing device 1 according to the above embodiment is described.

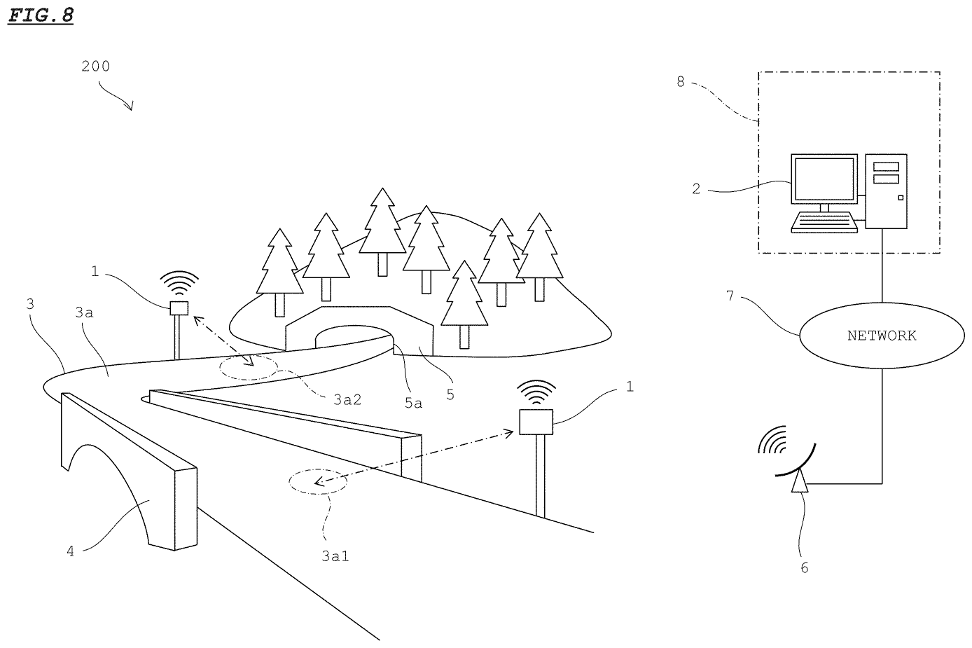

FIG. 8 schematically shows a configuration of a road surface information delivery system 200.

The road surface information delivery system 200 includes the moisture sensing device 1 and a management server 2. In the example in FIG. 8, a road 3 extends through a bridge 4 and an exit 5a of a tunnel 5, and is continued to the inside of the tunnel 5.

The moisture sensing device 1 is installed via a pole or the like on a lateral side of the road 3. The moisture sensing device 1 is also installed to an outdoor lamp, a wall surface, or the like installed on a lateral side of the road 3. The moisture sensing device 1 detects the state of a road surface 3a of the road 3. In FIG. 8, two moisture sensing devices 1 are shown. The moisture sensing device 1 on the near side senses the state of a region 3a1 of the road surface 3a positioned on the bridge 4. The moisture sensing device 1 on the far side senses the state of a region 3a2 of the road surface 3a positioned near the exit 5a of the tunnel 5. The moisture sensing device 1 determines the state (the type, thickness, etc., of a deposit) of moisture in each sensing target region of the road surface 3a, and transmits a determination result to the management server 2 via a base station 6 and a network 7.

The base station 6 is installed so as to include the moisture sensing device 1 in a communicable range, and is configured to be wirelessly communicable with the moisture sensing device 1. In this case, the output part 130 in FIG. 3 is implemented by a communication module. The base station 6 is connected to the network 7. The network 7 is the Internet, for example.

The management server 2 is installed at a road surface status delivery center 8 or the like, and is connected to the network 7. On the basis of information regarding the road surface state delivered by the moisture sensing device 1, the management server 2 generates map information for making notification of the state of the road surface 3a, and delivers the generated map information to a vehicle or the like via the network 7 and the base station 6. The delivered map information is displayed on a display part of a car navigation system mounted on a vehicle. A driver can confirm the displayed content to understand the state of the road surface 3a of the traveling path. Accordingly, safety during traveling on the road surface 3a can be enhanced.

Other than this, the moisture sensing device 1 may be mounted on a vehicle. In this case, for example, the moisture sensing device 1 is installed in the vehicle such that illumination light L1 is applied to the road surface immediately below the vehicle. The moisture sensing device 1 senses the road surface state immediately below the vehicle, and causes the sensing result to be displayed in a navigation system of the vehicle. Sensing of the road surface state is performed also during traveling of the vehicle, and the sensing result is displayed at the navigation system at appropriate times. Accordingly, the driver can accurately understand the state of the road surface during the current traveling.

In this case, further, the sensing result of the road surface by the moisture sensing device 1 may be transmitted, together with information indicating the current travelling position, from the navigation system to the management server 2 in FIG. 8, to be aggregated in the management server 2. Accordingly, on the basis of the aggregated sensing results of the road surface from vehicles, the management server 2 can generate finer map information indicating the state of the road. The driver can more accurately understand the state of the road that can be a traveling path.

### Effects of Embodiment

According to the embodiment, the following effects are exhibited.

As shown in FIG. 1, the optical axis A1 of the projection optical system 20 and the optical axis A2 of the light-receiving optical system 30 are aligned with each other in a range on the road surface side (the target object side). Therefore, reflected light R1, out of the reflected lights reflected by the road surface (target object), that travels backward along the aligned optical axis A10 can be condensed on the photodetector 40 by the light-receiving optical system 30. Therefore, the angles of illumination light L1 and reflected light R1 with respect to the road surface need not be adjusted in accordance with the distance between the moisture sensing device 1 and the road surface. Without such adjustment, the reflected light R1 from the road surface can be appropriately received by the photodetector 40, and the state (water, ice, snow) of moisture at the target object can be sensed.

Therefore, for example, in the system configuration example in FIG. 8, adjustment work at the time of installation can be simplified, and the moisture sensing device 1 can be easily installed. In a case where the moisture sensing device 1 is installed to a vehicle, even when the distance to the road surface changes moment to moment, the state of the road surface can be sensed without problems. Therefore, the moisture sensing device 1 can be installed to a mobile body such as a vehicle.

As shown in FIG. 2A and FIG. 2B, the optical element 31 includes: the opening 31b which allows illumination light L1 to pass therethrough to be guided to the road surface; and the reflection surface 31a which is formed around the opening 31b and which reflects reflected light R1 to be guided to the photodetector 40. Accordingly, while decrease in use efficiency of the reflected light R1 is suppressed, the optical axes of the illumination light L1 and the reflected light R1 can be aligned with each other.

Here, the reflection surface 31a is formed as a paraboloid that condenses reflected light R1 onto the photodetector 40, and is included as a component of the light-receiving optical system 30. Thus, there is no need to separately provide a condenser lens or the like for condensing reflected light R1 onto the photodetector 40. Therefore, simplification of the configuration of the moisture sensing device 1 and cost reduction can be realized.

As shown in FIG. 1, the light source part 10 includes the plurality of light sources 11, 12, 13 which emit lights having wavelengths different from each other, and the projection optical system 20 includes the alignment optical system 20a which aligns the emission optical axes of the respective light sources 11, 12, 13 with each other. Since the emission optical axes of the respective light sources 11, 12, 13 are aligned to the optical axis A1, the optical axis A1 and the optical axis A2 of the light-receiving optical system 30 can be aligned by the optical element 31 in a simple manner.

Here, the alignment optical system 20a includes the dichroic mirror 24 which aligns the emission optical axes of the light source 11 and the light source 12 with each other. Accordingly, the emission optical axes of these light sources 11, 12, which have emission wavelengths that are different to a great extent, can be easily aligned with each other.

In this configuration, as described above, when the detection sensitivity at the photodetector 40 is lower at the emission wavelength (the reference wavelength) of the light source 11 than at the emission wavelength (the absorption wavelength 1) of the light source 12, it is preferable to dispose the light sources 11, 12 with respect to the dichroic mirror 24 such that loss of light at the reference wavelength at the dichroic mirror 24 is less than loss of light at the absorption wavelength 1 at the dichroic mirror 24. Accordingly, attenuation due to the dichroic mirror 24 of illumination light L1 having the reference wavelength can be suppressed, and the amount of reflected light R1 having the reference wavelength received at the photodetector 40 can be ensured. Therefore, the magnitude of the detection signal of reflected light R1 having the reference wavelength at which the detection sensitivity is lowest can be prevented from becoming extremely small.

As shown in FIG. 1, the alignment optical system 20a includes the PBS 25 which aligns the emission optical axis of the light source 13 with the emission optical axes of the light source 11 and the light source 12. The polarization directions of the light sources 11, 12, 13 are set such that, out of illumination lights L1 having the reference wavelength, the absorption wavelength 1, and the absorption wavelength 2, at least the illumination light L1 having the reference wavelength at which the detection sensitivity at the photodetector 40 is lowest is p-polarized with respect to the road surface (target object). Accordingly, as described with reference to FIG. 6A and FIG. 6B, decrease in the light reception efficiency at the photodetector 40 of the reflected light R1 having the reference wavelength can be suppressed. Therefore, the magnitude of the detection signal of the reflected light R1 having the reference wavelength at which the detection sensitivity is low can be prevented from becoming extremely small, and the determination of the type of a deposit shown in FIG. 5 and the determination of the thickness of the deposit can be accurately performed.

As shown in FIG. 5, the determination part 111 determines a deposit (snow, ice, water) on the road surface on the basis of the values R11, R12 obtained by normalizing the detection signals with respect to the two detection illumination lights L1 having the absorption wavelengths 1, 2 by the detection signal with respect to the reference illumination light L1 having the reference wavelength. Thus, when the detection signals with respect to the illumination lights L1 having the absorption wavelengths 1, 2 are normalized by the detection signals with respect to the illumination light L1 having the reference wavelength which is less likely to be influenced by moisture, noise components such as scattering due to the shape of the road surface can be suppressed. Therefore, the state (the type of a deposit) of moisture on the road surface can be accurately determined.

### Modification 1

The configuration of the moisture sensing device 1 can be modified in various ways other than the configuration shown in the above embodiment.

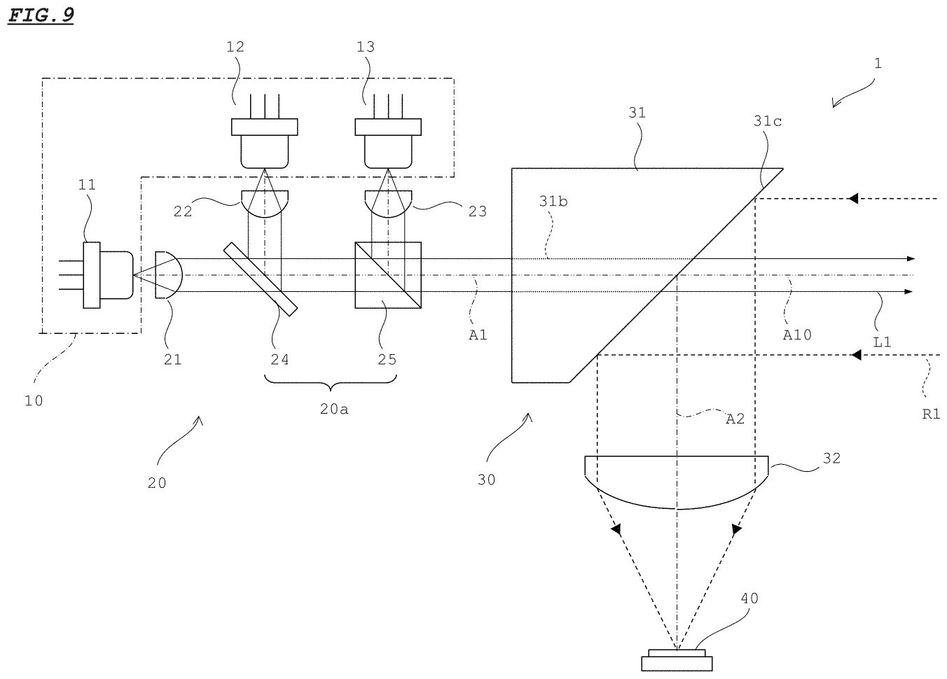

FIG. 9 shows a configuration of an optical system of the moisture sensing device 1 according to Modification 1.

In the configuration in FIG. 9, when compared with the configuration in FIG. 1, a reflection surface 31c of the optical element 31 is implemented as a plane, and a condenser lens 32 for condensing reflected light R1 onto the photodetector 40 is added as a component of the light-receiving optical system 30. The other configuration is the same as that in FIG. 1. As the condenser lens 32, a spherical lens can be used, for example.

In the configuration in FIG. 9 as well, the optical axis A1 of the projection optical system 20 and the optical axis A2 of the light-receiving optical system 30 are aligned with the optical axis A10 by the optical element 31. Therefore, similar to the above embodiment, the angles of illumination light L1 and reflected light R1 with respect to the road surface need not be adjusted in accordance with the distance between the moisture sensing device 1 and the road surface. Without such adjustment, the reflected light R1 from the road surface can be appropriately received by the photodetector 40.

However, in the configuration in FIG. 9, when compared with the configuration in FIG. 1, the condenser lens 32 is separately added. Thus, the configuration in FIG. 9 is slightly complicated, and cost is increased. Due to spherical aberration and chromatic aberration at the condenser lens 32, the condensed state of the reflected light R1 at the light-receiving surface of the photodetector 40 is slightly impaired when compared with that in the above embodiment.

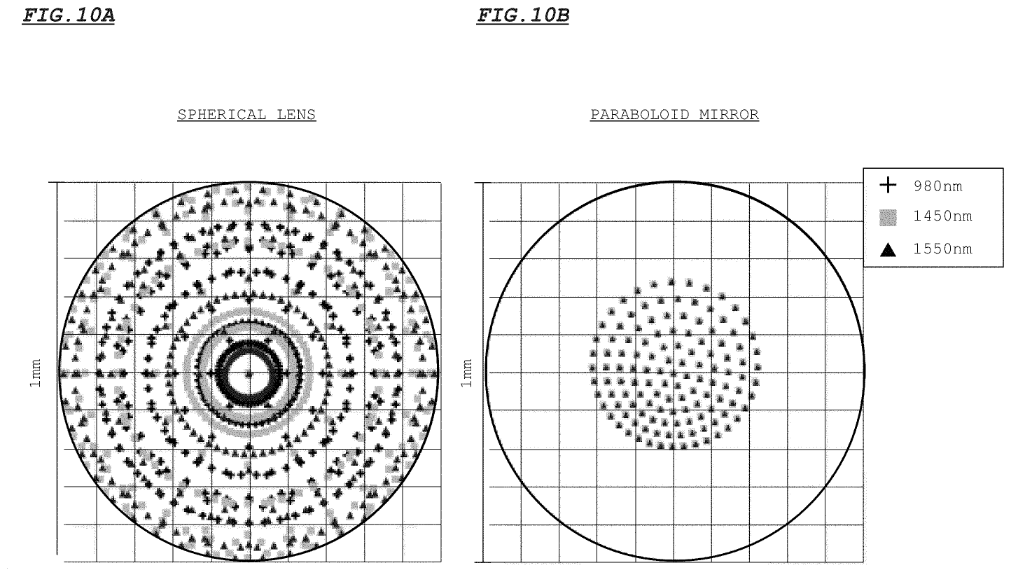

FIG. 10A and FIG. 10B respectively show simulation results obtained through simulation of condensed states of reflected lights R1 when the reflected lights R1 have been condensed on the photodetector 40 by the condenser lens 32 (Modification 1) and by the reflection surface 31a (embodiment).

In this simulation, a validation condition was set such that infrared lights (reflected lights R1) having wavelengths of 980 nm, 1450 nm, and 1550 nm emitted from a point light source at a distance of 10 m were condensed on a 1 mm light-receiving surface by using a spherical lens (the condenser lens 32) having a diameter of 50 mm and a focal length of 100 mm and a paraboloid mirror (the reflection surface 31a).

FIG. 10A and FIG. 10B show distributions of rays of infrared lights having respective wavelengths (980 nm, 1450 nm, and 1550 nm) on the light-receiving surface of the photodetector 40, the distributions having been obtained when reflected lights R1 of respective illumination lights L1 having the reference wavelength (980 nm), the absorption wavelength 1 (1450 nm), and the absorption wavelength 2 (1550 nm) have been condensed by the condenser lens 32 and by the reflection surface 31a having a paraboloid shape.

As shown in FIG. 10A, when reflected lights R1 have been condensed by using a spherical lens (the condenser lens 32), rays of the reflected lights are distributed over the entirety of the light-receiving surface, and in addition, the condensing positions of the rays are different for each wavelength. In contrast to this, when reflected lights R1 have been condensed by using a paraboloid mirror (the reflection surface 31a), when compared with the case where the spherical lens (the condenser lens 32) has been used, it is seen that the reflected lights R1 are condensed in a small region, and in addition, the rays of the reflected lights R1 of all the wavelengths pass through the same positions.

Thus, as in the case of the above embodiment, when reflected lights R1 are condensed by using the paraboloid mirror (the reflection surface 31a), influences of spherical aberration and chromatic aberration can be suppressed. Therefore, in the configuration of the above embodiment, when compared with the configuration of Modification 1 shown in FIG. 9, a smaller photodetector 40 can be used and the detection accuracy of the reflected lights R1 having the respective wavelengths can be enhanced.

<Modification 2>

In the above embodiment, the optical axis A1 of the projection optical system 20 and the optical axis A2 of the light-receiving optical system 30 are aligned with each other by using the optical element 31 having the reflection surface 31a and the opening 31b. In contrast to this, in Modification 2, the optical axis A1 of the projection optical system 20 and the optical axis A2 of the light-receiving optical system 30 are aligned with each other by using a small mirror.

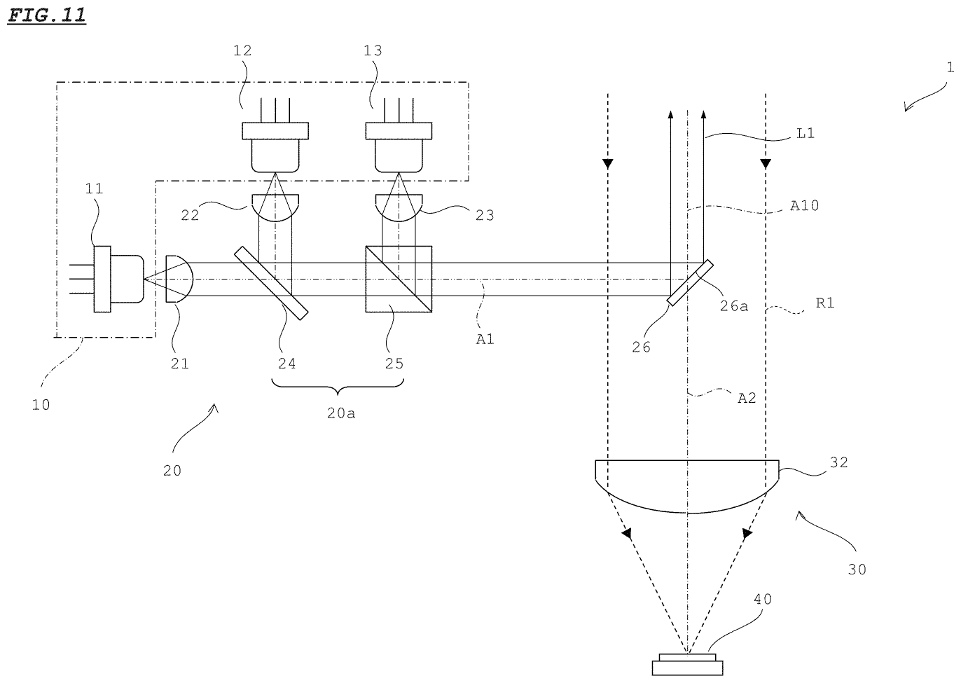

FIG. 11 shows a configuration of an optical system of the moisture sensing device 1 according to Modification 2.

In the configuration in FIG. 11, when compared with the configuration in FIG. 1, the optical element 31 is omitted, and an optical element 26 is added as a component of the projection optical system 20. In the configuration in FIG. 11, similar to the configuration in FIG. 9, the condenser lens 32 is added as a component of the light-receiving optical system 30. The other configuration is the same as that in FIG. 1.

The optical element 26 is a mirror having a flat plate shape. A reflection surface 26a of the optical element 26 is slightly larger than the beam size of illumination light L1 having been made into collimated light by the collimator lenses 21, 22, 23. The shape of the optical element 26 is a shape that corresponds to the beam shape of the illumination light L1 incident on the optical element 26. The optical element 26 reflects the illumination light L1 and allows reflected light R1 passing through the periphery around the optical element 26 to be guided to the photodetector 40. The optical element 26 bends the optical axis A1 of the projection optical system 20 in a direction parallel to the optical axis A2 of the light-receiving optical system 30, to align the optical axes A1, A2 with each other. The optical element 26 is disposed at a position where the optical axis A1 of the projection optical system 20 and the optical axis A2 of the light-receiving optical system 30 cross each other.

In the configuration in FIG. 11 as well, the optical axis A1 of the projection optical system 20 and the optical axis A2 of the light-receiving optical system 30 can be aligned with the common optical axis A10 by the optical element 26. Therefore, similar to the above embodiment, the angles of illumination light L1 and reflected light R1 with respect to the road surface need not be adjusted in accordance with the distance between the moisture sensing device 1 and the road surface. Without such adjustment, the reflected light R1 from the road surface can be appropriately received by the photodetector 40.

In the configuration in FIG. 11, similar to the configuration in FIG. 9, the reflected lights R1 are condensed by the condenser lens 32 onto the photodetector 40. Therefore, as described with reference to FIG. 10A and FIG. 10B, the reflected lights R1 are subjected to influence of spherical aberration and chromatic aberration by the condenser lens 32. This influence is eliminated by using a paraboloid mirror instead of the condenser lens 32.

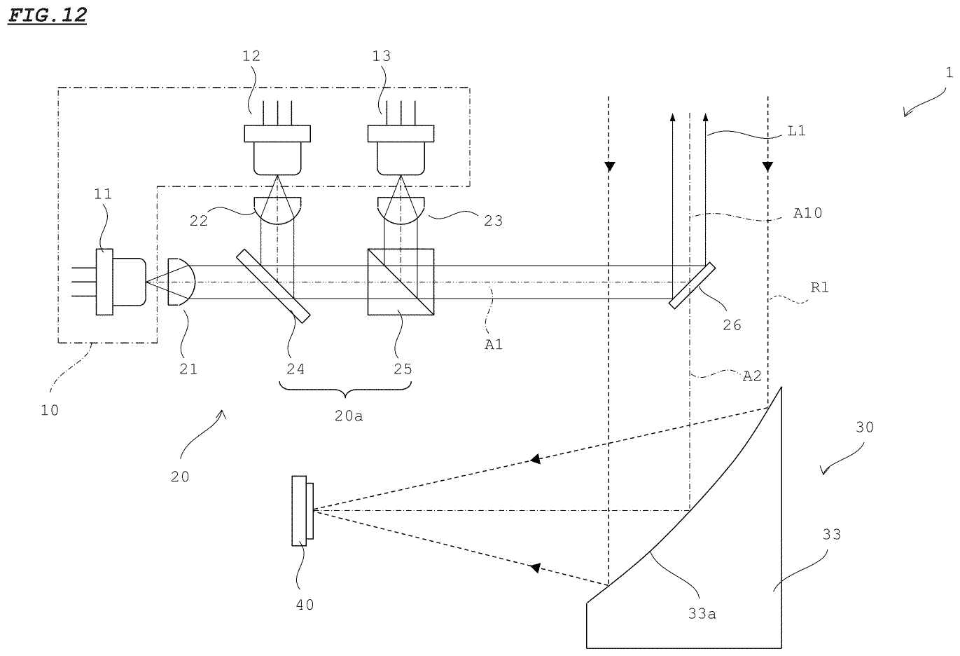

FIG. 12 shows a configuration of an optical system of the moisture sensing device 1 obtained by replacing the condenser lens 32 with a paraboloid mirror 33, in the configuration in FIG. 11.

The paraboloid mirror 33 has a reflection surface 33a having a paraboloid shape. The reflection surface 33a has a shape similar to the shape of the reflection surface 31a, shown in FIG. 2A and FIG. 2B, from which the opening 31b is omitted. The reflection surface 33a perpendicularly bends the optical axis A2 of the light-receiving optical system 30, and condenses reflected lights R1 onto the light-receiving surface of the photodetector 40. The bending angle of the optical axis A2 is not limited to 90 degrees, and may be another angle. In this configuration, the paraboloid mirror 33 is included as a component of the light-receiving optical system 30.

In the configuration in FIG. 12, reflected lights R1 are condensed by the paraboloid mirror 33, and thus, influence of spherical aberration and chromatic aberration on the reflected lights R1 can be eliminated. Therefore, when compared with the configuration in FIG. 11, a smaller photodetector 40 can be used, and the detection accuracy of the reflected lights R1 having the respective wavelengths can be enhanced.

<Modification 3>

In the above embodiment, the alignment optical system 20a is composed of the dichroic mirror 24 and the PBS 25. In contrast to this, in Modification 3, a dichroic mirror 27 is used instead of the PBS 25.

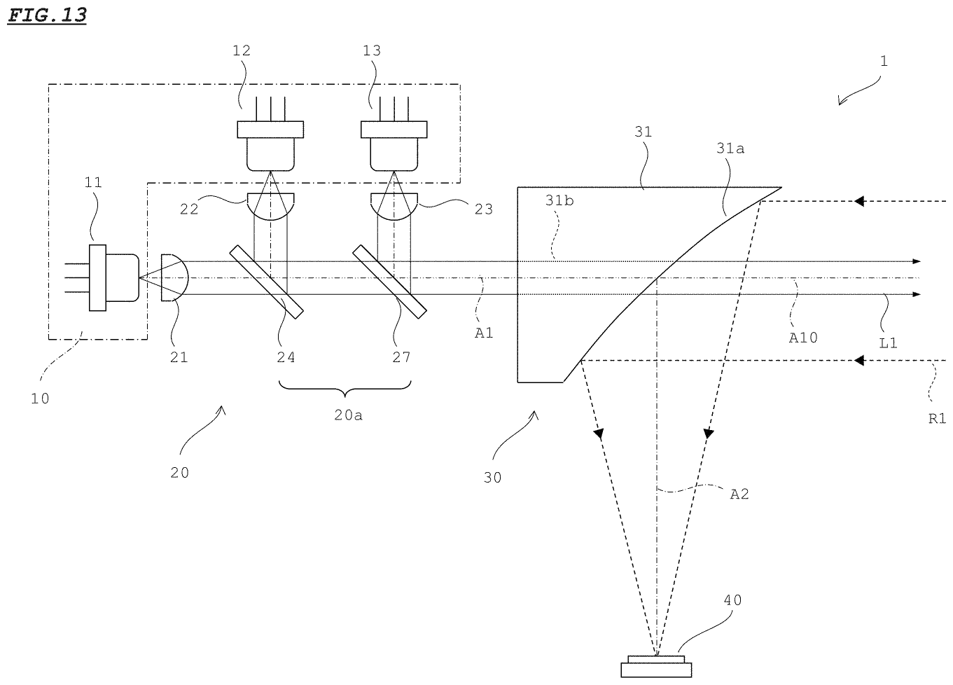

FIG. 13 shows a configuration of an optical system of the moisture sensing device 1 according to Modification 3.

In the configuration in FIG. 13, the PBS 25 in the configuration in FIG. 1 is replaced with the dichroic mirror 27. The other configuration is the same as that in FIG. 1. The dichroic mirror 27 allows transmission therethrough of illumination lights L1 having the reference wavelength and the absorption wavelength 1 and respectively emitted from the light sources 11, 12, and reflects illumination light L1 having the absorption wavelength 2 and emitted from the light source 13. Accordingly, the emission optical axes of the light sources 11, 12, 13 are aligned with each other.

In this configuration as well, effects similar to those of the above embodiment can be exhibited.

In the configuration in FIG. 13 as well, it is preferable that the light source that emits illumination light L1 having a wavelength at which the detection sensitivity at the photodetector 40 is low is disposed such that the illumination light L1 is p-polarized with respect to the road surface. In addition, it is preferable that the arrangement of the light sources 11, 12, 13 is adjusted such that attenuations at the dichroic mirrors 24, 27 are suppressed with respect to the illumination light L1 having the wavelength at which the detection sensitivity at the photodetector 40 is low.

In this configuration, when the wavelength difference between the absorption wavelengths 1, 2 is small, there is a possibility that: the transmission efficiency of the dichroic mirror 27 with respect to the absorption wavelength 1 decreases; and the reflection efficiency of the dichroic mirror 27 with respect to the absorption wavelength 2 decreases. Therefore, the configuration in FIG. 13 can be applied when the transmission efficiency and the reflection efficiency of the dichroic mirror 27 with respect to the absorption wavelengths 1, 2 can be ensured to be at high levels, even in a case where the wavelength difference between the absorption wavelengths 1, 2 is the wavelength difference shown in FIG. 4. When the configuration in FIG. 13 is used, the absorption wavelengths 1, 2 may be set such that the wavelength difference is greater than that according to the setting method in FIG. 4, in a range where the determination shown in FIG. 5 can be performed. Accordingly, the transmission efficiency and the reflection efficiency of the dichroic mirror 27 with respect to the absorption wavelengths 1, 2 can be ensured to be at high levels.

### OTHER MODIFICATION

In the above embodiment, lights having three kinds of wavelength are used as illumination lights L1. However, the number of kinds of wavelength used for illumination lights L1 is not limited to three. For example, the type of a deposit may be determined by using two light sources that respectively emit illumination light L1 having a reference wavelength and illumination light L1 having an absorption wavelength, and a radiation temperature sensor that detects the temperature of the road surface. In this case, either one of the dichroic mirror 24 and the PBS 25 is omitted from the alignment optical system 20a.

In the above embodiment, the presence or absence of snow on the road surface is determined by comparing the threshold Ith with the received-light intensity Ir of the reflected light R1 having the reference wavelength. However, the thickness of snow may be further measured by using a TOF (Time Of Flight) sensor that measures the distance to a target object on the basis of a time period from when illumination light L1 is projected from the projection optical system 20 and then reflected by a target object to when the reflected light is received by the photodetector 40. When the TOF sensor is used, the thickness of snow can be accurately measured.

In the above embodiment, light having the reference wavelength and emitted from the light source 11 is near infrared light having a wavelength of 980 nm. However, the reference wavelength is not limited to 980 nm, and may be another wavelength at which absorption by water is little. The light having the reference wavelength is not limited to near infrared light, and may be visible light having a wavelength of not greater than 750 nm. However, when the light having the reference wavelength is visible light, the road surface 3a is irradiated with the visible light, which may cause a trouble in the traffic on the road 3. Therefore, the light having the reference wavelength is preferably near infrared light.

The shape and the size of optical components forming the optical system are not limited to those shown in the above embodiment and Modifications 1 to 3, and can be changed as appropriate. For example, the optical element 31 shown in FIG. 1 may have a plate-like shape, or the paraboloid mirror 33 shown in FIG. 12 may have a plate-like shape.

In the determination process shown in FIG. 5, the type of a deposit on the road surface is determined. However, the determination target is not limited thereto. The thickness, slipperiness, or the like of the deposit may further be determined.

In the above embodiment and each modification, the state (water, ice, snow) of moisture on the road surface is sensed. However, the target object for which the state of moisture is sensed is not necessarily limited to the road surface. For example, the present invention may be applied to a moisture sensing device that senses the state of moisture on a surface of a floor or a desk, or a moisture sensing device that senses moisture on a leaf. In this case, in accordance with the type or the like of moisture to be sensed, the number and kinds of lights to be used in sensing may be adjusted.

Further, the application examples of the moisture sensing device 1 are not limited to the road surface information delivery system 200 shown in FIG. 8 and an application example in which the moisture sensing device 1 is mounted on a vehicle. The moisture sensing device 1 may be used in another configuration in which the state of moisture of a target object is detected by using illumination light and reflected light.

In addition to the above, various modifications can be made as appropriate to the embodiment of the present invention, without departing from the scope of the technological idea defined by the claims.

What is claimed is:

1. A moisture sensing device comprising:
a light source part;
a projection optical system configured to project illumination light emitted from the light source part, onto a target object;
a photodetector configured to receive reflected light of the illumination light reflected by the target object;
a light-receiving optical system configured to condense the reflected light onto the photodetector; and
an optical element configured to align an optical axis of the projection optical system and an optical axis of the light-receiving optical system with each other in a range on a side of the target object.

2. The moisture sensing device according to claim 1, wherein
the optical element includes: an opening configured to allow the illumination light to pass therethrough to be guided to the target object; and a reflection surface formed around the opening and configured to reflect the reflected light to be guided to the photodetector.

3. The moisture sensing device according to claim 2, wherein
the reflection surface is a paraboloid configured to condense the reflected light onto the photodetector, and is included as a component of the light-receiving optical system.

4. The moisture sensing device according to claim 1, wherein
the optical element is a mirror configured to reflect the illumination light and allow the reflected light passing through a periphery around the optical element to be guided to the photodetector, and is included as a component of the projection optical system.

5. The moisture sensing device according to claim 1, wherein
the light source part includes a plurality of light sources configured to emit lights having wavelengths different from each other, and
the projection optical system includes an alignment optical system configured to align emission optical axes of the respective light sources with each other.

6. The moisture sensing device according to claim 5, wherein
the light source part includes a first light source, a second light source, and a third light source configured to respectively emit lights having a first wavelength, a second wavelength, and a third wavelength different from each other, and
the alignment optical system includes a dichroic mirror configured to align emission optical axes of the first light source and the second light source with each other.

7. The moisture sensing device according to claim 6, wherein
when detection sensitivity at the photodetector is lower at the first wavelength than at the second wavelength, the first light source and the second light source are disposed with respect to the dichroic mirror such that loss of light at the first wavelength at the dichroic mirror is less than loss of light at the second wavelength at the dichroic mirror.

8. The moisture sensing device according to claim 6, wherein
the alignment optical system includes a polarization beam splitter configured to align an emission optical axis of the third light source with the emission optical axes of the first light source and the second light source, and
polarization directions of the first light source, the second light source, and the third light source are set such that, out of lights having the first wavelength, the second wavelength, and the third wavelength, at least light for which detection sensitivity at the photodetector is lowest is p-polarized with respect to the target object.

9. The moisture sensing device according to claim 6, comprising
a determination part configured to determine a deposit on the target object on the basis of a detection signal from the photodetector, wherein
out of the first light source, the second light source, and the third light source, two light sources each emit detection light having a wavelength at which absorption coefficients with respect to water and ice are high, and a remaining one light source emits reference light having a wavelength at which absorption coefficients with respect to water and ice are low, and
the determination part determines the deposit on the basis of signals obtained by normalizing the detection signals with respect to the two detection lights by the detection signal with respect to the reference light.

10. The moisture sensing device according to claim 9, wherein
the determination part determines water, ice, and snow as the deposit.
